(19) United States
(12) Patent Application Publication
(10) Pub. No.: US 2005/0032030 A1
(43) Pub. Date: Feb. 10, 2005

(54) Digital notebook

(76) Inventors: Tzong-Wei Uen, Miao Li City (TW); Shun-Bin Lin, Zhang Hua Hsien (TW)

Correspondence Address: RUBEN C. DELEON, 100 CRESCENT COURT, SUITE 700, DALLAS, TX, 75201, US

(21) Appl. No.: 10/633,994

(22) Filed: Aug. 4, 2003

(51) Int. Cl. G09B 5/00; G09G 5/00; G06K 9/00

(52) U.S. Cl. 434/317; 382/187; 345/156

(57) ABSTRACT

A digital notebook with ASIC has disclosed in the present invention. By way of electromagnetic induction to detect the handwriting trail, a digital data can be introduced by the ASIC and stored in a storage media. Beside, the digital data can be shared by transmitting through the transmission interface to other electrical instruments, wherein the electrical instruments can be personal computer, PDA, printer, mobile-phone or other electrical apparatuses with the capability of receiving, displaying and arranging digital data.

### BACKGROUND OF THE INVENTION

1. Field of the Invention

The invention is related to a digital notebook, especially, it is related to a multi-functional digital notebook.

2. Description of the Prior Art

The contemporary electronic technologies are fast developed, many new product are continuously appeared, both software and hardware. For example, the traditional operating interfaces of the electronic devices are keyboard and/or mouse, but the new operating interface, such as hand-write inputting, voice inputting and screen-touch inputting, are commercial products in the recent years. Moreover, the human is used to hand-write for several thousand years, especially to write and speak simultaneously. Hence, the tablet is popular in the recent years, because it allows the user to input the word or the picture by directly writing but not by choosing them from the screen by the mouse or the keyboard.

However, most of the contemporary electronic products only use one new technology, such as the microphone used by the voice-inputting technology or the screen used by the touch-inputting technology, but seldom integrate different newly present operating interfaces. At most, an electronic product (computer or personal digital assistant or others) are connected to two or more operating interface, such that the user is able to choose which operating interface is used now and which operating interface is used later.

Besides, the current operating interfaces of the electronic device are designed to transform the human expressions, such as voice or words or pictures or others, into the electronic records (or ever be printed), but the daily-life of the user usually need the records that are available anytime and anywhere (for example, the notes used in the office for recording suddenly discussions). Clearly, the current operating interfaces are suitable for many requirements but are not suitable for some cases that the informations must be used, recorded, carried and conveniently distributed simultaneously. For example, by using the contemporary electronic technologies, the user is convenient to transmit the records from his tablet to his personal digital assistant, but it is difficult to share the records with other persons while none of the persons has personal digital assistant or there is no printed to print out the records.

Significantly, although the contemporary electronic technologies are fast developed, the designed direction and the applied method of the current electronic products still is limited and then the operating interface still is not convenient enough for the user.

### SUMMARY OF THE INVENTION

In accordance with the present invention, a digital notebook with ASIC that can combine the conventional notebook with the skill of input handwriting in accordance with the requirement in industry is provided in this invention for improving and strengthen application of product so as to achieve the objective whose problems cannot be solved by the conventional input-interface of handwriting.

One of the objects in this invention is to provide a digital notebook that further satisfy the user's daily-life requirement and is suitable for both electronic inputting and conventional inputting, and further is related to the application specific integrated circuit and related circuit module. Especially, without clearly increasing cost and inducing technology problems, an application specific integrated circuit and the related circuit module for both electrical file recording and paper writing. Herein, the new digital notebook comprises the functions for sound recording and wireless network communication. Thus, the present invention fits in with the commercial benefit and industrial utility.

To satisfy the previous objects, the invention presents a digital notebook with an application specific integrated circuit. By way of electromagnetic induction to detect the handwriting trail, a digital data can be introduced by the ASIC and stored in a storage media. Beside, the digital data can be shared by transmitting through the transmission interface to other electrical instruments, wherein the electrical instruments can be personal computer, PDA, printer, mobile-phone or other electrical apparatuses with the capability of receiving, displaying and arranging digital data

### BRIEF DESCRIPTION OF THE DRAWINGS

FIG. 1A is a structure diagram of the disclosed digital notebook in the preferred embodiment of the invention;

FIG. 1B is circuit diagram of the handwriting of pictures and literary handling system in the preferred embodiment of the invention; and

FIG. 1C is the structure diagram of the handwriting of pictures and literary inputting system in the embodiment of the present invention.

### DESCRIPTION OF THE PREFERRED EMBODIMENT

What is probed into in the invention is about a digital notebook. Detailed description of the digital notebook will be provided in the following description in order to make the invention thoroughly understood. Obviously, the application of the invention is not confined to specific details familiar to those who are skilled in the chitosan membrane. On the other hand, the common elements and procedures that are known to everyone are not described in the details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

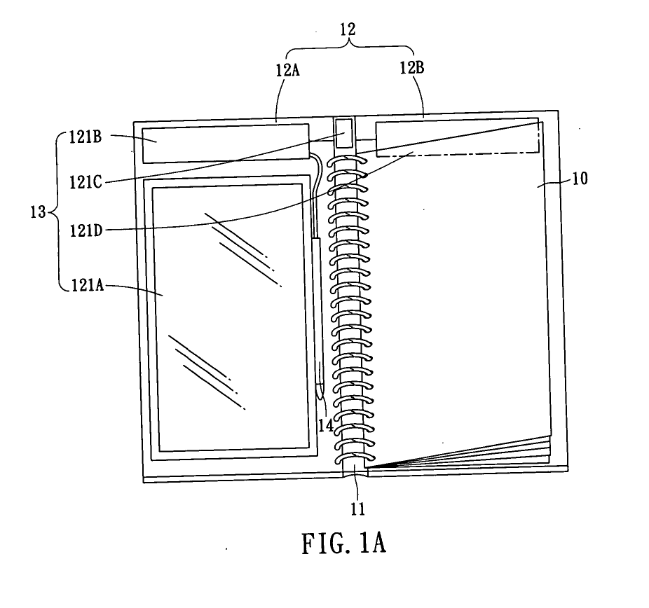

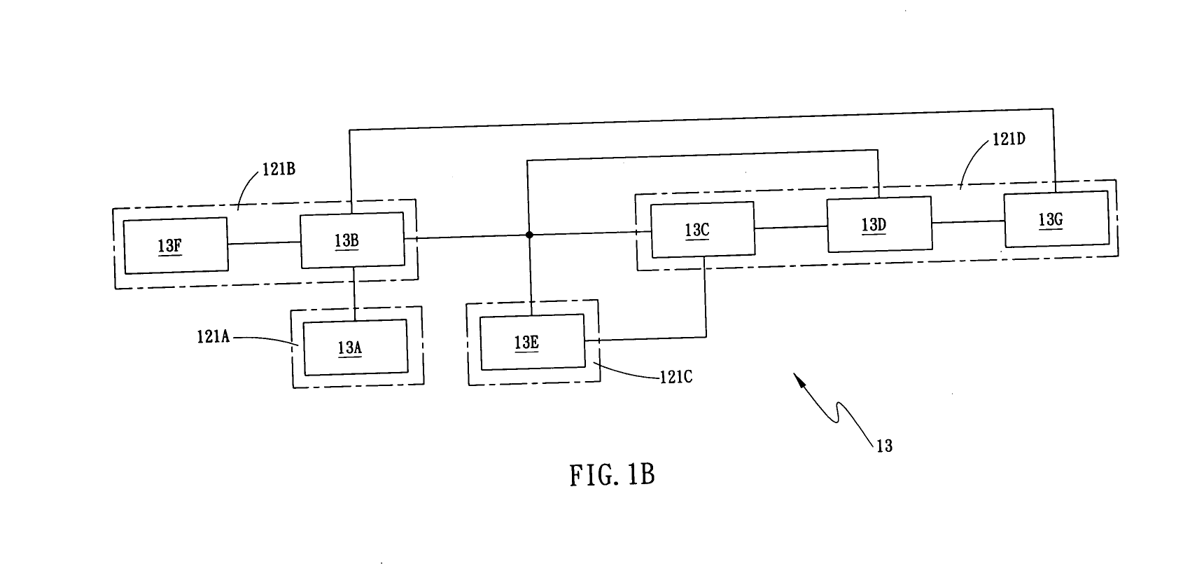

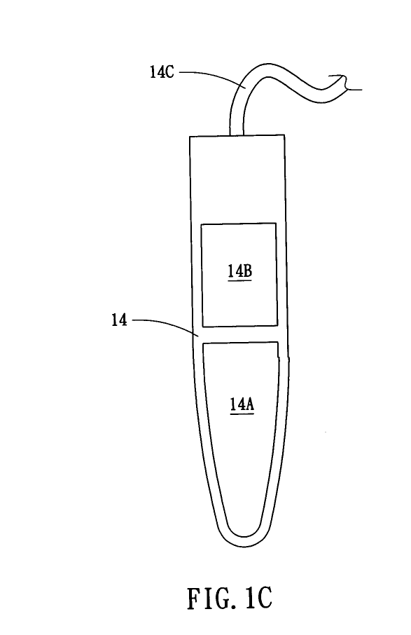

Referring to FIG. 1A, one embodiment of the present invention provides a digital notebook, comprising: a paper 10, a fasten means 11, an outer covering 12, a handwriting of pictures and literary handling system 13, and a handwriting of pictures and literary inputting system 14. The outer covering 12 comprises two mutual connected covering means: a first covering means 12A and a second covering means 12B. The fastening means 11 is located between the first means 12A and the second means 12B to fasten the paper 10 and to make the overturning of the paper 10 available between the first covering means 12A and the second covering means 12B. Thus, the handwriting of pictures and literary writing system 14 can be used for writing the handwriting of pictures and literary on the paper 10. Besides, the fastening means 11 can be located at a surface on one of the first covering means 12A and the second covering means 12B. Furthermore, the above mentioned handwriting of pictures and literary handling system 13 can be located between the paper 10 and the outer covering 12. That is, the handwriting of pictures and literary handling system 13 is inside the first covering means 12A or the second covering means 12B.

Referring to FIG. 12A and FIG. 12B, in the embodiment, the handwriting of pictures and literary handling system 13 is set in a first area 121A and a second area 121B of the first covering means 12A, a third area 121C of the fastening means, and a fourth area 121D of the second covering means 12B. The handwriting of pictures and literary handling system 13 further comprises: an electromagnetic induction sub-circuit 13A, the electromagnetic induction sub-circuit 13A is used for detecting the handwriting of pictures and literary written on the paper 10 to generate a first signal; an application specific integrated circuit 13B, the application specific integrated circuit 13B is electrically coupled with the electromagnetic induction sub-circuit 13A to receive the first signal to generate a second signal with digital data of the handwriting of pictures and literary; a storage sub-circuit 13C, wherein the storage sub-circuit 13C is electrically coupled with the application specific integrated circuit 13B to access the second signal and the third signal within the storage sub-circuit 13C; a transmission sub-circuit 13D, wherein the transmission sub-circuit 13D is electrically coupled with the application specific integrated circuit 13B to communicate the second signal and the inputting of the external signal with the peripheral electrical apparatuses; a sound recording sub-circuit 13E, wherein the sound recording sub-circuit 13E is electrically coupled with the application specific integrated circuit 13B to receive a sound signal, and the sound signal is transformed into a third signal with digital signal of the sound signal, wherein the third signal is communicated by the transmission sub-circuit 13D and stored and accessed by the storage sub-circuit 13D; a power sub-circuit 13F to receive the external power and to supply the power to the digital notebook, wherein the power sub-circuit 13F comprises all kinds of applicable batteries. Besides, the above mentioned electromagnetic induction sub-circuit 12A is in the first area 121A, the power sub-circuit 13F and the application specific integrated circuit 13B are in the second area 121B, the sound recording sub-circuit 13E is in the third area 121C, and the storage sub-circuit 13C and the transmission sub-circuit 13D are in the fourth area 121D.

In addition, the above mentioned storage sub-circuit 13C further comprises disks, flash memories, portable memory cards, or the same. Besides, the transmission sub-circuit 13D comprises wireless communication interface and wired communication interface. The wired communication interface includes IEEE 1394, RS-232, PS/2, IEEE 802.11, USB and so on. Moreover, the wireless communication interface includes infrared ray communication interface, microwave communication interface, bluetooth communication interface and the kind. Moreover, the above mentioned peripheral electrical apparatuses personal computer, PDA, printer, mobile phone, FAX or other electrical apparatuses with the capabilities to receive, display and handling above mentioned handwriting of pictures and literary.

Referring to FIG. 1A and FIG. 1B, in the embodiment, the handwriting of pictures and literary handling system further comprising a wireless network communication sub-circuit 13G. The wireless network communication sub-circuit 13G is electrically coupled with the application specific integrated circuit 13B to control the wireless network communication and is also electrically coupled with the transmission sub-circuit 13D to perform the wireless communication with the external communication system (i.e. GPRS communication system or WAP communication system). Besides, the wireless network communication sub-circuit 13G can be directly integrated into the application specific integrated circuit 13B.

Referring to FIG. 1A and FIG. 1C, in the embodiment, the handwriting of pictures and literary inputting system 14 comprises a writing means 14A and a signaling means 14B. The writing means 14A is used for writing the handwriting of pictures and literary on the paper, and the signaling means 14B is used for performing the interaction of electromagnetic induction to generate the first signal on writing. Besides, the handwriting of pictures and literary inputting system 14 can use the writing means 14A and the signaling means 14B to advanced handling, such as document dealing, computing or file management and so on. It is not only to identify the handwriting of pictures and literary written by the users. Moreover, the advanced handling can be performed in the digital notebook with the functions for handwriting and storing, or in the external computers after wired/wireless transmission. Comparing to the prior art, no matter the traditional handwriting or the present handwriting panel, the present invention has better complexity and convenience. Moreover, the invention is acquired by the original view of incorporating two well-known inputting devices to provide a new and particular inputting interface. Hence, while the invention is used as a commercial product, there is no necessarily to clearly modify the conventional paper-pen way or the current hand-write inputting device, and also no necessarily to improve any new technology difficulty.

Although the embodiment has been illustrated and described, it will be obvious to those skilled in this art that various modifications may be made without departing from what is intended to be limited solely by the appended claims. Obviously, many modifications and variations of the present invention are possible in light of the above teachings. It is therefore to be understood that within the scope of the appended claims, the present invention may be practiced otherwise than as specifically described herein.

1. A digital notebook, comprising:
an outer covering;
a paper, said paper is connected on said outer covering by a fastening means;
a handwriting of pictures and literary handling system with a electromagnetic induction sub-circuit and an application specific integrated circuit, wherein said handwriting of pictures and literary handling system is located in said outer covering, and said electromagnetic induction sub-circuit is used for detecting the handwriting of pictures and literary written on said paper to generate a first signal, wherein said application specific integrated circuit is electrically coupled with said electromagnetic induction sub-circuit to receive said first signal to generate a second signal with digital data of the handwriting of pictures and literary; and
a handwriting of pictures and literary inputting system, wherein said handwriting of pictures and literary inputting system is used for writing the handwriting of pictures and literary on said paper and perform the interaction of electromagnetic induction to generate said first signal on writing.

2. The digital notebook of claim 1, wherein said handwriting of pictures and literary handling system comprising a transmission sub-circuit, wherein said transmission sub-circuit is electrically coupled with said application specific integrated circuit to communicate said second signal.

3. The digital notebook of claim 1, wherein said handwriting of pictures and literary handling system comprising a storage sub-circuit, wherein said storage sub-circuit is electrically coupled with said application specific integrated circuit to access said second signal within said storage sub-circuit.

4. The digital notebook of claim 1, wherein said handwriting of pictures and literary handling system comprising a sound recording sub-circuit, wherein said sound recording sub-circuit is electrically coupled with said application specific integrated circuit to receive a sound signal, and said sound signal is transformed into a third signal with digital signal of said sound signal.

5. The digital notebook of claim 1, wherein said handwriting of pictures and literary handling system comprising a power sub-circuit to supply the power to said digital notebook.

6. The digital notebook of claim 2, wherein said handwriting of pictures and literary handling system comprising a wireless network communication sub-circuit, wherein said wireless network communication sub-circuit is electrically coupled with said application specific integrated circuit to control the wireless network communication, and said wireless network communication sub-circuit is also electrically coupled with said transmission sub-circuit to perform the wireless communication with the external communication system.

7. The digital notebook of claim 1, wherein said handwriting of pictures and literary inputting system comprising a line, wherein said line is electrically coupled with said handwriting of pictures and literary handling system to supply the power to handwriting of pictures and literary inputting system.

8. The digital notebook of claim 1, wherein said handwriting of pictures and literary inputting system comprising a electric current generating sub-circuit to supply the power to handwriting of pictures and literary inputting system by the interaction of electromagnetic induction.

9. The digital notebook of claim 1, wherein said handwriting of pictures and literary handling system comprising an application program to make a electric signature.

10. A digital notebook, said digital notebook comprise:
an outer covering;
a paper, said paper is connected on said outer covering by a fastening means;
a handwriting of pictures and literary handling system located in said outer covering, comprising:
an electromagnetic induction sub-circuit, said electromagnetic induction sub-circuit is used for detecting the handwriting of pictures and literary written on said paper to generate a first signal;
an application specific integrated circuit, said application specific integrated circuit is electrically coupled with said electromagnetic induction sub-circuit to receive said first signal to generate a second signal with digital data of the handwriting of pictures and literary;
a sound recording sub-circuit, wherein said sound recording sub-circuit is electrically coupled with said application specific integrated circuit to receive a sound signal, and said sound signal is transformed into a third signal with digital signal of said sound signal;
a storage sub-circuit, wherein said storage sub-circuit is electrically coupled with said application specific integrated circuit to access said second signal and said third signal within said storage sub-circuit; and
a transmission sub-circuit, wherein said transmission sub-circuit is electrically coupled with said application specific integrated circuit to communicate said second signal, said third signal and the inputting of the external signal with the peripheral electrical apparatuses; and
a handwriting of pictures and literary inputting system, wherein said handwriting of pictures and literary inputting system is used for writing the handwriting of pictures and literary on said paper and perform the interaction of electromagnetic induction to generate said first signal on writing.

11. The digital notebook of claim 10, wherein said handwriting of pictures and literary handling system comprising a power sub-circuit to supply the power to said digital notebook.

12. The digital notebook of claim 10, wherein said application specific integrated circuit perform the wireless communication by using said transmission sub-circuit with the external communication system.

13. The digital notebook of claim 10, wherein said handwriting of pictures and literary inputting system, comprising:
a writing means, said writing means is used for writing the handwriting of pictures and literary on said paper; and
a signaling means, said signaling means is used for performing the interaction of electromagnetic induction to generate said first signal on writing.

14. The digital notebook of claim 10, wherein said handwriting of pictures and literary inputting system comprising a line, wherein said line is electrically coupled with said handwriting of pictures and literary handling system to supply the power to handwriting of pictures and literary inputting system.

15. The digital notebook of claim 10, wherein said handwriting of pictures and literary inputting system comprising a electric current generating sub-circuit to supply the power to handwriting of pictures and literary inputting system by the interaction of electromagnetic induction.

16. A digital notebook, said digital notebook comprise:
an outer covering, wherein said outer covering comprises a first covering means and a second covering means, and said first covering means and said second covering means are connected by a fastening means, wherein said first covering means comprises a first area and a second area, and said fastening means and second covering means comprises a third area and a fourth area separately;
a paper, said paper is connected on said outer covering by a fastening means;
a handwriting of pictures and literary handling system located in said outer covering, comprising:
an electromagnetic induction sub-circuit in said first area, said electromagnetic induction sub-circuit is used for detecting the handwriting of pictures and literary written on said paper to generate a first signal;
an application specific integrated circuit in said second area, said application specific integrated circuit is electrically coupled with said electromagnetic induction sub-circuit to receive said first signal to generate a second signal with digital data of the handwriting of pictures and literary;
a sound recording sub-circuit in said third area, wherein said sound recording sub-circuit is electrically coupled with said application specific integrated circuit to receive a sound signal, and said sound signal is transformed into a third signal with digital signal of said sound signal;
a storage sub-circuit in said fourth area, wherein said storage sub-circuit is electrically coupled with said application specific integrated circuit to access said second signal and said third signal within said storage sub-circuit;
a transmission sub-circuit in said fourth area, wherein said transmission sub-circuit is electrically coupled with said application specific integrated circuit to communicate said second signal, said third signal and the inputting of the external signal with the peripheral electrical apparatuses; and
a wireless network communication sub-circuit in said fourth area, wherein said wireless network communication sub-circuit is electrically coupled with said application specific integrated circuit to control the wireless network communication, and said wireless network communication sub-circuit is also electrically coupled with said transmission sub-circuit to perform the wireless communication with the external communication system; and
a handwriting of pictures and literary inputting system, wherein said handwriting of pictures and literary inputting system is used for writing the handwriting of pictures and literary on said paper and perform the interaction of electromagnetic induction to generate said first signal on writing.

17. The digital notebook of claim 16, wherein said handwriting of pictures and literary handling system comprising a power sub-circuit to supply the power to said digital notebook.

18. The digital notebook of claim 16, wherein said handwriting of pictures and literary inputting system, comprising:
a writing means, said writing means is used for writing the handwriting of pictures and literary on said paper; and
a signaling means, said signaling means is used for performing the interaction of electromagnetic induction to generate said first signal on writing.

19. The digital notebook of claim 16, wherein said handwriting of pictures and literary inputting system comprising a line, wherein said line is electrically coupled with said handwriting of pictures and literary handling system to supply the power to handwriting of pictures and literary inputting system.

20. The digital notebook of claim 16, wherein said handwriting of pictures and literary inputting system comprising a electric current generating sub-circuit to supply the power to handwriting of pictures and literary inputting system by the interaction of electromagnetic induction.
